(19) United States
(12) Patent Application Publication
(10) Pub. No.: US 2018/0315408 A1
(43) Pub. Date: Nov. 1, 2018

(54) MECHANICAL REVERBERATION DEVICE

(71) Applicant: Harman International Industries, Inc., Stamford, CT (US)

(72) Inventor: Tom CRAM, Salt Lake City, UT (US)

(21) Appl. No.: 15/499,451

(22) Filed: Apr. 27, 2017

(51) Int. Cl. G10H 1/045; G10H 3/18

(52) U.S. Cl. CPC G10H 1/045; G10H 2210/285; G10H 3/186

(57) ABSTRACT

A reverberation device includes a mechanical delay device in the form of a coil from an elongate strip of metal in an example embodiment. The length can be greater than an order of magnitude greater than the height dimension. The height dimension is greater than the thickness dimension. The mechanical delay device can be fed an audio signal from an electro-mechanical transducer and output mechanical vibrations to a mechanical-electrical transducer. The coil can be folded at the center of the coil so that the input and output are both on the outside of the coil. The input path is interleaved with the output path for the signal in the coil.

### TECHNICAL FIELD

Aspects of the present disclosure provide a reverberation device for acoustic signal processing and, more specifically, a reverberation device with new mechanical spring.

### BACKGROUND

Reverberation is an added effect that adds an echo component to music. Reverberation can be produced by the design of the room in which the audio is being performed. The sound waves can reflect off surfaces in the room to create an echo. This can be referred to as natural reverberation. In some cases, the reverberation effect produced using a digital signal processor that can add a delayed signal to the audio signal before it is output from a loudspeaker using a digital processor. The digital processor may store packets of audio signal and release them at a time period. In a spring reverberation, the audio signal is converted to a mechanical signal and fed through the spring and thereafter converted to an audio signal. The reverberation output signal is then output with the original signal nut shifted in time to produce the echo or delay effect. A mechanical reverberation system can include a room sized metal plate in which an audio signal is input at one side and sensed at another side

### SUMMARY

As described herein a reverberation device to produce an echo effect or reverberation effect for an audio signal includes a flat metal spiral. A reverberation device can include an input for an audio signal, a mechanical delay coil to receive the audio signal to produce a delayed audio signal, the coil including an elongate body having a length dimension that is wound around itself with a height less than the length and a thickness less than the height, and an output to output the audio signal and the delayed audio signal to produce an audio output signal.

In an example embodiment, the elongate body of the coil is a planar strip that is wound into a spiral to form a delay path for a mechanical audio signal.

In an example embodiment, a top edge of the spiral wound elongate body is a top plane and wherein a bottom edge of the spiral wound elongate body is a bottom plane.

In an example embodiment, the delay coil includes an input path starting at an input terminal, an output path ending at an output terminal, and a center node that joins the input path to the output path.

In an example embodiment, the input path and the output path are interleaved.

In an example embodiment, the input path has an audio signal travel in a first direction and the output path has the audio signal travel in a second direction that is opposite to the first direction.

In an example embodiment, the input terminal is on an opposite side of the coil relative to the output terminal.

In an example embodiment, the delay coil has a constant height with a top of turns of the delay coil being in a same first plane and the bottom of turns of the delay coil being in a same second plane.

In an example embodiment, the input path and the output path are equally spaced until the center node.

In an example embodiment, the delay coil includes a wound metal body that includes linear sides joined by corners.

In an example embodiment, the length dimension is an order of magnitude greater than the height.

In an example embodiment, the height is at least five times the thickness dimension.

In an example embodiment, the delay coil has a constant height with a top of turns of the delay coil being in a same first plane and the bottom of turns of the delay coil being in a same second plane.

In an example embodiment, a reverberation device may include an input for an audio signal, a mechanical delay coil to receive the audio signal to produce a delayed audio signal, the coil including an elongate body having an input end, an output end, and a length between the input end and the output, the length of the body is wound around itself, the elongate body having a height less than the length and a thickness less than the height, the input end being connected to the input. In an example embodiment, an output is provided to output the audio signal and the delayed audio signal to produce an audio output signal, the output being connected to the output end.

In an example embodiment, the input includes an input transformer to transform an input audio signal to a mechanical signal at the input edge of the elongate body and an output transformer to transform the mechanical signal transmitted through the elongate body to a further electrical signal at the output edge of the elongate body.

In an example embodiment, the elongate body is a planar strip that is wound into a spiral to form a delay path for a mechanical audio signal.

In an example embodiment, a top edge of the spiral wound elongate body is a top plane and wherein a bottom edge of the spiral wound elongate body is a bottom plane.

In an example embodiment, the delay coil includes an input path starting at an input terminal, an output path ending at an output terminal, and a center node that joins the input path to the output path.

In an example embodiment, the input path and the output path are interleaved.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 shows a musical system using a reverberation device according to an example embodiment;

FIG. 2 shows a schematic view of a reverberation device according to an example embodiment;

FIG. 3 shows a perspective view of a delay coil for a reverberation device according to an example embodiment;

FIG. 4 shows a plan view of a delay coil for a reverberation device according to an example embodiment;

FIG. 5 shows an elevational view of a delay coil for a reverberation device according to an example embodiment; and

FIG. 6 shows a reverberation device with a delay coil according to an example embodiment.

### DETAILED DESCRIPTION

As required, detailed embodiments are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Reverberation devices can add an echo to the audio output signal. Some reverberation devices use digital signal processing, while others use mechanical delays. Examples of mechanical delays include springs having narrow width dimension wires that are wound in three dimensions. The present disclosure describes various embodiments of wound coil reverberation structures to output a synthetic reverberation signal that can be added back to the output signal after a delay. The coil may be a wound elongate metal plate, e.g., a strip of metal having a length significantly longer than its height or its thickness. The strip of metal is wound in two dimensions. The coil may provide delay effects with an improved signal transmission through the coil relative to a spring that has a wire construction with a constant diameter.

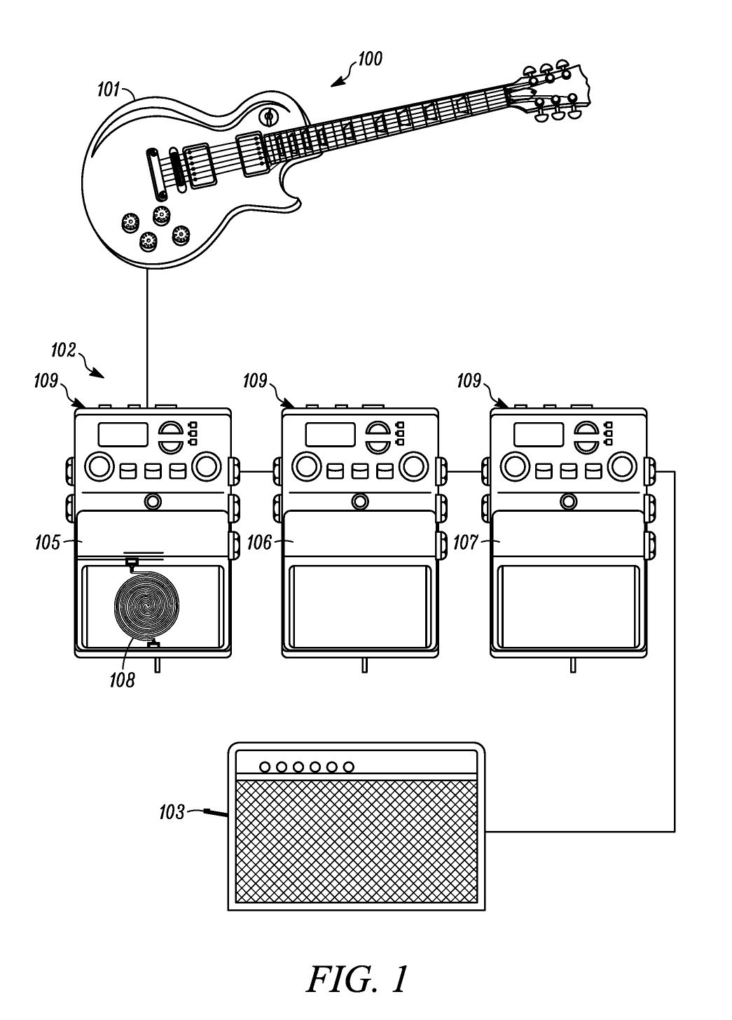

FIG. 1 shows a schematic view of a system 100 for producing an audio signal using a musical instrument 101 as an input through an effects stage 102 and then to an output stage 103. The musical instrument 101 is illustrated as a stringed instrument, e.g., a guitar, however, the present disclosure is not limited to guitars. Other musical instruments may be used to produce an instrument output audio signal. The musical instrument 101 outputs a musical audio signal, e.g., a pickup acts a transducer that detects the strings vibrations and converts then to an electrical signal that is sent to the effects stage 102. In the case where the musical instrument is an acoustic instrument, a microphone may sense the audio output and convert it to an electrical signal. The electrical signal can be sent via a wire or a wireless channel to the effects stage 102.

The effects stage 102 can include one or more effects devices 105, 106, 107. It will be appreciated that the effects boxes must be activated to produce an effect, e.g., a delay or reverberation. The audio signal that is without effects is sometimes referred to as “dry” and an effect-processed signal is “wet”. The effects device in the off mode may pass a dry audio signal. The effects device 105, 106, or 107 may be process a signal to produce the wet or processed signal. A pedal-style effects device may be called a “stompbox”, “effects pedal” or “pedal”. A pedal style effects device 105-107 can be a rectangular housing with a first dimension of about 3 inches to about 6 inches and a second dimension of about 2 inches to about 4 inches. A musician may bring many effects devices to a live show or recording session and may mount the pedals on a guitar pedalboard, to reduce set-up and tear-down time. The pedalboards can include a removable cover protect the pedals during transportation. A musician may also mount multiple effect devices in a rack mounted road case. When rackmounted effect devices are mounted in a roadcase, this also speeds up a musician's set-up and tear-down time, because all of the effect devices can be connected together inside the rack case and all of the effect devices can be plugged into a powerbar with a known input at a first effect, a known sequence of effect devices and a known output from the last effect device. At least one of the effects devices, e.g., device 105, can include a delay coil 108. The effects devices 105-107 may include controls 109 to set the amount of delay or otherwise control effect being imparted by the individual effects device. The delay coil 108 can be an elongate metal plate that is wound into a spiral. The delay coil 108 can delay part of the audio signal via mechanical transmission of the audio signal through the delay coil. This adds a delay to the audio signal. The delayed signal can be added back to the non-delayed audio signal to provide a delay or reverberation effect. The output from the effects box 105 can be fed to the next effects box in a sequence of effects boxes or to the output stage 103. The next effects box 106 can also include a delay coil to add additional delay or reverberation to the audio signal. The output from this effects box 106 can be output to an additional effects box 107 and so on. Any one or more of the effects devices 105-107 can include a delay coil. The delay coil 108 can provide the benefits of a plate type delay in a space that is less is typically required for a plate-type reverberation. The output from the effects box 106 or 107 can be output to the output stage 103.

The output stage 103 receives the audio signal output from the effects stage 102. This audio signal includes all of the effects, if any, that are imparted by the effects devices 105-107, e.g., a delay from a delay coil 108. Some effects devices may be built into an amplifier as the output stage 103. The amplifier can include a delay coil to produce a delay in the audio signal to produce a reverberation effect. The output stage 103 can include further signal processing and an amplifier. The amplifier outputs the amplified audio signal to at least one loudspeaker.

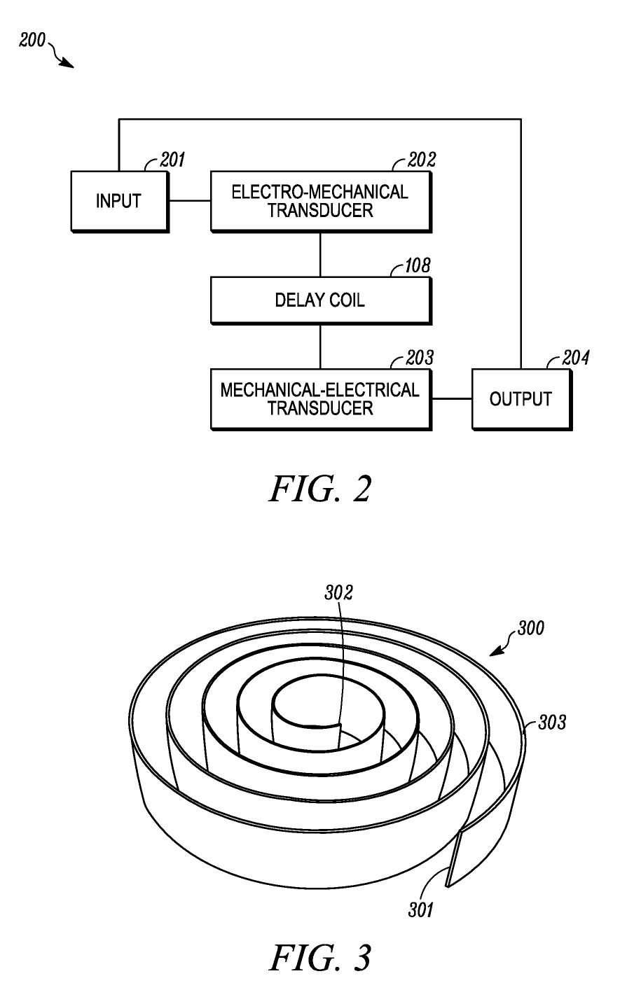

FIG. 2 shows a schematic view of an embodiment of a reverberation device 200. An input 201 receives an electrical, audio signal, e.g., from a musical instrument. The input 201 can pass the audio signal to the output 204 and to an electrical-mechanical transducer 202. The electrical-mechanical transducer 202 converts the electrical, audio signal to a mechanical signal that is input to the delay coil 105 at an input terminal of the coil. The mechanical signal travels through the delay coil 105. The delay coil 105 has a path length that is longer than the electrical path from the input 201 to the output 204. Moreover, the mechanical signal also travels at a slower speed through the delay coil than the electrical signal from the input to the output. At the end terminal of the delay coil 108 remote from the input terminal, a mechanical to electrical transducer 203 converts the mechanical signal to an electrical signal. The mechanical to electrical transducer 203 outputs a delayed audio signal to the output 204. The output 204 combines the audio signal with the delayed audio signal, e.g., by a summing circuit, and outputs the combined electrical signal to further electrical devices, e.g., effects devices, amplifier circuitry or and output stage.

FIG. 3 shows a perspective view of the delay coil 300 for a producing a reverberation effect. The delay coil 300 has an input terminal end 301 and an output terminal end 302 to receive and transmit an audio signal therethrough with a delay relative to an audio signal that does not enter the delay coil. The delay is a function of the length of the coil. The input terminal end 301 is configured to receive a mechanical audio signal from an output from an electro-mechanical transducer (not shown in FIG. 3). The terminal end input 301 is at the beginning node of the signal transmission path 303. The transmission path 303 is counterclockwise through the spiral body of the elongate strip of thin metal plate. The output terminal end 302 is at the center of the spiral wound body. The output terminal end 302 is configured to receive the mechanical audio signal that is transmitted along the length of the coil 300 to output the coil transmitted signal to mechanical-electrical transducer (not shown in FIG. 3). The length of the coil 300 is longer than both the height and the thickness of the metal strip that forms the coil. The length of the metal strip is at least fifty times its height. The length of the metal strip can be at least one hundred times its height. The length of the metal strip can be at least one, and in some embodiments, more than two orders of magnitude greater than the height. The height of the metal strip is greater than its thickness, e.g., at least five times, eight times, ten times or more.

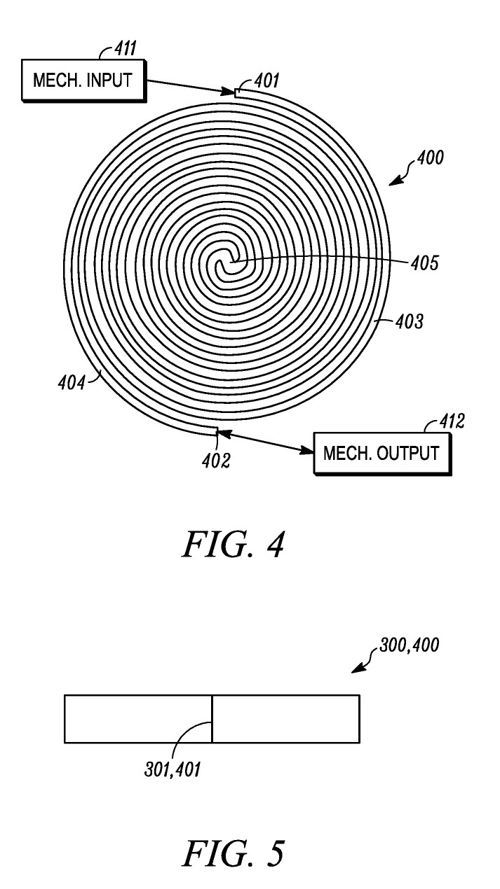

FIG. 4 shows a plan view of the coil 400 for producing a reverberation effect. The coil 400 has an input terminal end 401 and output terminal end 402 to receive and transmit an audio signal, respectively. The input terminal end 401 is configured to receive a mechanical audio signal from an output from an electro-mechanical transducer 411. The input terminal end 401 is at the beginning node of the input path 403. The output terminal end 402 is configured to receive the mechanical audio signal that is transmitted along the length of the coil 400 to output the coil-transmitted signal to mechanical-electrical transducer 412. The output terminal end 402 is at the end node of the output path 404. The coil is folded at the center 405 to join the input path 403 and the output path 404. The input path 403 is interleaved with the output path 404. In this example, the input terminal end 401 and the output terminal end 402 are both on the outside of the coil and spaced apart around the periphery of the coil. In an example, the input terminal end 401 is on the opposite side of the coil, e.g., about 180 degrees, from the output terminal end 402. The coil 400 effectively doubles the length of the coil by interleaving the input path 403 with the output path 404 with the paths being joined at a center node 405. As show in in FIG. 4, the input travel path for the audio signal is in a first direction (here, clockwise) on the input path 403. The output travel path for the audio signal is in a second direction (here, counterclockwise) on the output path 404. The audio signal reverses its travel direction at the center node 405. The delay coil is formed of a strip of metal, e.g., with dimensions as described herein in various embodiments.

FIG. 5 shows an elevational view of the delay coil 300, 400 for a producing a reverberation effect. The input terminal end 301, 401 is shown. The dimension of delay coil can be those as described herein. The delay coil 300, 400 is wound in two dimensions and does not extend upwardly or downwardly in the elevational view of FIG. 5.

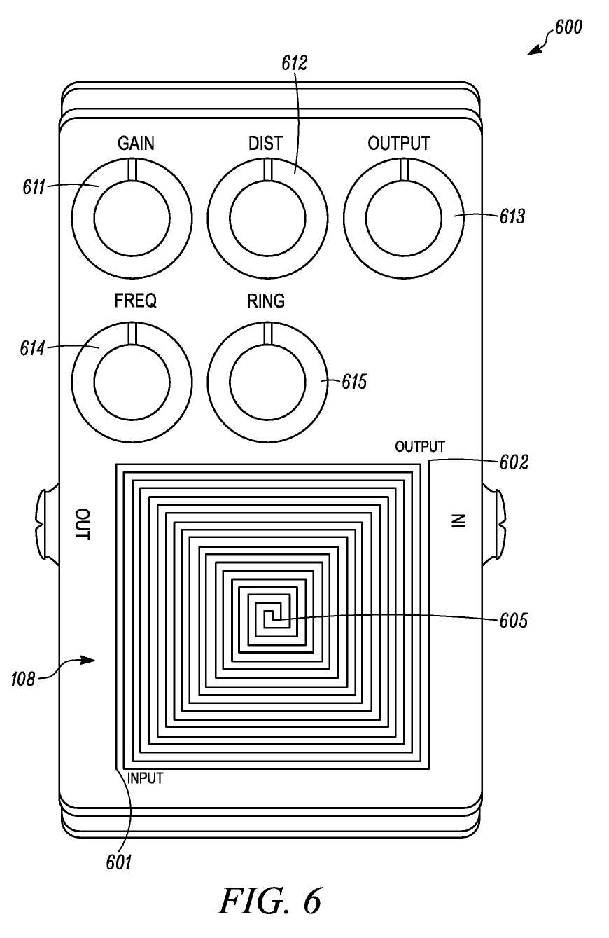

FIG. 6 shows schematic view of a reverberation effects device 600 with a delay coil 108. The effects device 600 includes a plurality of controls 609. The controls 609 include a gain control 611 to control the gain control circuitry in the effects device 600. The gain control circuitry operated to increase or decrease the amount of distortion gain being applied to the audio signal. A distortion control 612 controls distortion circuitry to increase or decrease the distortion output level. An output control 613 controls the output circuitry to adjust the overall output level of the audio signal, when the effect is on. A frequency control 614 controls frequency circuitry to adjust the frequency of the carrier signal wave being applied to the original audio input signal. A ring control 615 controls a ring circuitry to adjust the ring modulation output level, when the effect is on. The effect device 600 can be turned on or off by depressing a footswitch, not shown. The ring circuitry includes the delay coil 108. The delay coil 108 includes an input terminal end 601 and an output terminal end 602. The coil 108 is interleaved to have an input path and an output path and is joined at the center node 605. This delay coil 108 includes squared corners, e.g., about 90 degrees, or rounded corners than provide an ell turns. The metal strip that forms the coil may have the dimensions as described herein. In an example, the length of metal strip is up to three orders of magnitude of the height.

The delay coil as described herein can be placed under tension to control the delay effect produced by the delay coil. The above descriptions of the delay coil in an effects box is shown. The delay coil provides a plate structure, i.e., an elongate strip, to provide a delay in a small housing. The delay coil is not a helical spring. The top of the delay coil is in the same plane in an example embodiment. The bottom of the delay coil is in the same plane in an example embodiment.

The present disclosure describes devices to create a mechanical reverberation that will fit into pedal-sized enclosure. Unlike conventional reverberation devices that input a signal to an inches long metal spring or to a room-sized metal plate with the output being received by a pickup, various embodiments of the present disclosure use a flat metal spiral coil. Both prior delay devices are quite large and bulky and not suitable for effects pedals or integration into some musical instruments. Embodiments of the present delay coil is not a coil spring. Embodiments of the presently described delay coil have a length dimension that is its greatest dimension. The height dimension can be its second largest dimension, which is less than an order of magnitude or two orders of magnitude less than the length dimension. The thickness dimension is the smallest dimension and is less than an eighth of the height dimension. In an example, the coil can have a length that is essentially doubled by having a spiral folded back on itself with a turn at the center of the coil. The input and the output from the coil are both on the outside of the coil. The length of the coil determines the time period of the delay for the reverberation. Such a coil can be placed in a effects pedal, e.g., a stomp box, that can be used on stage by a musician.

The embodiments of the present disclosure generally provide for a plurality of circuits or other electrical devices, e.g., the musical instrument, the electrical device, the loudspeaker and the sound system. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical/operational implementation that is desired. It is recognized that any circuit or other electrical device disclosed herein may include any number of microprocessors, integrated circuits, filters, resistors, operational amplifiers, memory devices (e.g., FLASH, random access memory (RAM), read only memory (ROM), electrically programmable read only memory (EPROM), electrically erasable programmable read only memory (EEPROM), or other suitable variants thereof) and instructions (e.g., software) which co-act with one another to perform operation(s) disclosed herein. In addition, any one or more of the electric devices may be configured to execute a computer-program that is embodied in a computer readable medium that is programmed to perform any number of the functions and features as disclosed. The computer readable medium may be non-transitory or in any form readable by a machine or electrical component.

The present disclosure refers to the delay/reverberation coil mounted in an effects pedal. The reverberation coil can be mounted in a control panel or mixing board that can be part of an output stage 103. The control panel or mixing board can then provide mechanical reverb effects in additional to possibly providing digital music processing effects. The control panel or mixing board can provide both digital reverb and the mechanical reverb.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

We claim:

1. A reverberation device, comprising:
an input for an audio signal;
a mechanical delay coil to receive the audio signal to produce a delayed audio signal, the coil including an elongate body having a length dimension that is wound around itself with a height less than the length and a thickness less than the height; and
an output to output the audio signal and the delayed audio signal to produce an audio output signal.

2. The reverberation device of claim 1, wherein the elongate body is a planar strip that is wound into a spiral to form a delay path for a mechanical audio signal.

3. The reverberation device of claim 2, wherein a top edge of the spiral wound elongate body is a top plane and wherein a bottom edge of the spiral wound elongate body is a bottom plane.

4. The reverberation device of claim 1, wherein the delay coil includes an input path starting at an input terminal, an output path ending at an output terminal, and a center node that joins the input path to the output path.

5. The reverberation device of claim 4, wherein the input path and the output path are interleaved.

6. The reverberation device of claim 5, wherein the input path has an audio signal travel in a first direction and the output path has the audio signal travel in a second direction that is opposite to the first direction.

7. The reverberation device of claim 6, wherein the input terminal is on an opposite side of the coil relative to the output terminal.

8. The reverberation device of claim 7, wherein the delay coil has a constant height with a top of turns of the delay coil being in a same first plane and the bottom of turns of the delay coil being in a same second plane.

9. The reverberation device of claim 7, wherein the input path and the output path are equally spaced until the center node.

10. The reverberation device of claim 1, wherein the delay coil includes a wound metal body that includes linear sides joined by corners.

11. The reverberation device of claim 1, wherein the length dimension is an order of magnitude greater than the height.

12. The reverberation device of claim 10, wherein the height is at least five times the thickness dimension.

13. The reverberation device of claim 11, wherein the delay coil has a constant height with a top of turns of the delay coil being in a same first plane and the bottom of turns of the delay coil being in a same second plane.

14. A reverberation device, comprising:
an input for an audio signal;
a mechanical delay coil to receive the audio signal to produce a delayed audio signal, the coil including an elongate body having an input end, an output end, and a length between the input end and the output, the length of the body is wound around itself, the elongate body having a height less than the length and a thickness less than the height, the input end being connected to the input; and
an output to output the audio signal and the delayed audio signal to produce an audio output signal, the output being connected to the output end.

15. The reverberation device of claim 14, wherein the input includes an input transformer to transform an input audio signal to a mechanical signal at the input edge of the elongate body and an output transformer to transform the mechanical signal transmitted through the elongate body to a further electrical signal at the output edge of the elongate body.

16. The reverberation device of claim 15, wherein the elongate body is a planar strip that is wound into a spiral to form a delay path for a mechanical audio signal.

17. The reverberation device of claim 16, wherein a top edge of the spiral wound elongate body is a top plane and wherein a bottom edge of the spiral wound elongate body is a bottom plane.

18. The reverberation device of claim 17, wherein the delay coil includes an input path starting at an input terminal, an output path ending at an output terminal, and a center node that joins the input path to the output path.

19. The reverberation device of claim 18, wherein the input path and the output path are interleaved.
